(19) United States
(12) Patent Application Publication
(10) Pub. No.: US 2018/0304450 A1
(43) Pub. Date: Oct. 25, 2018

(54) Power Tool Adapter for Powder-Actuated Connecting Tool

(71) Applicant: Journeyman Tools LLC, Reno, NV (US)

(72) Inventor: Andrew John, Brentwood, CA (US)

(21) Appl. No.: 15/949,004

(22) Filed: Apr. 9, 2018

Related U.S. Application Data
(60) Provisional application No. 62/489,938, filed on Apr. 25, 2017.

(51) Int. Cl. B25B 27/00; H01R 4/50; H01R 43/027

(52) U.S. Cl. CPC B25B 27/0085; H01R 4/08; H01R 43/0275; H01R 4/5091

(57) ABSTRACT

A powder-driven connecting tool for connecting power lines is disclosed, as are assemblies and replacement parts for such a tool. The tool includes a tool head with an anvil, and a power unit with a ram. A breech cap assembly connects to the power unit and includes a sleeve threaded on both ends and a cap threadedly mounted on one end of the sleeve. The sleeve and cap define a breech for a powder charge. An adapter is mounted on an outer end surface of the cap. The adapter is narrower than the cap itself and is adapted to be driven by a power tool in order to tighten and loosen the cap and the sleeve. The adapter may, for example, have the form of a hex nut.

### CROSS-REFERENCE TO RELATED APPLICATIONS

This application claims priority to U.S. Provisional Patent Application No. 62/489,938, filed Apr. 25, 2017, the contents of which are incorporated by reference in their entirety.

### BACKGROUND OF THE INVENTION

### 1. Field of the Invention

In general, the invention relates to powder-actuated tools, and more specifically to an adapter for a powder-actuated tool.

### 2. Description of Related Art

An electrical transmission grid is used to transmit power from power plants to individual buildings using a combination of overhead transmission lines and buried or underground transmission lines. The transmission grid is configured to be modular, allowing for utility workers to replace old or damaged power lines, and additionally, to connect existing transmission lines to new lines. While a variety of connectors are used for these purposes, one particular wedge connector, referred to as an AMPACT® tap connector, has been widely used. While AMPACT® tap connectors are made in a variety of shapes and dimensions for any number of unique connections, the method of installation is relatively universal: a tapered wedge is forced between two conductors within a C-shaped housing or sleeve. This type of wedge connector generally ensures a solid electrical connection that can reliably withstand the elements, including weathering and thermal expansion.

Installation of these wedge connectors has become relatively efficient with the use of a powder-actuated tool. Variations on this tool have been used for some time; a more recent example is shown in U.S. Pat. No. 6,851,262 to Gregory et al., which is incorporated by reference in its entirety. This tool is commonly referred to as an AMPACT® connecting tool, and has become standard for utility crews working on high-voltage electrical lines. The AMPACT® tool uses the explosive force of a powder charge or cartridge to drive a steel ram that pushes the wedge of the connector into place, thus making a secure connection.

Despite the availability of pneumatic and electric versions of the AMPACT® tool, the powder-actuated version remains the most popular, as the powder-actuated tool does not require additional cables or batteries that may impede workflow. However, installing and removing the cartridge from the AMPACT® tool requires removal of a threaded breech. Loosening and tightening that breech takes time. Furthermore, the repetitive motion of loosening and then tightening the tool's breech can potentially cause strain to the operator's hands and wrists over time.

The usual solution to such issues of repetitive motion and hand strain is to use a tool to perform the task in question. However, hand tools may be difficult to use in threading and unthreading the breech, and offer the user little relief, either in terms of time or physical effort. A power tool, such as a battery-powered screw gun, would be able to perform the function, but for one problem: AMPACT® tools are not configured to accept or be manipulated with other tools. The knob that releases the breech is typically knurled for hand gripping, but is too large in diameter to grip with common socket drivers. Moreover, that portion of the breech carries the firing pin and various gas-release ports, which cannot be obstructed if the tool is to function properly.

### SUMMARY OF THE INVENTION

One aspect of the invention relates to an AMPACT® powder-actuated ram connecting tool with a gas release knob that has been modified so that it can be turned using a torque-applying tool. The modification comprises an adapter that is attached to the rearward-most surface of the gas release knob. The adapter itself has a form that can be easily engaged by torque-applying tools, and is typically of lesser width or diameter than gas release knob itself. For example, the adapter may have the form of a hexagonal nut or drive head, so that it can be driven by a hex wrench or socket, and may be arranged on the gas release knob in such a way that it does not obstruct gas release ports in the gas release knob.

Another aspect of the invention relates to a part assembly for an AMPACT® powder-actuated ram connecting tool. The part assembly is designed to replace the gas release knob and related structures of a typical tool, and includes a hollow cylindrical portion with a set of external threads that is capped on one end by a gas release knob of greater diameter than the cylindrical portion. Formed on the rearward-most surface of the gas release knob is an adapter that allows the gas release knob to be turned by a torque-applying tool. The adapter may, for example, have the shape and features of a hex head. The adapter is solid, and gas release ports extend through both the gas release knob and the adapter, terminating and opening at the rearward-most surface of the adapter. In some embodiments, a raised striking surface may protrude a small height from the rear of the adapter.

Other aspects, features, and advantages of the invention will be set forth in the description that follows.

### BRIEF DESCRIPTION OF THE DRAWINGS

The invention will be described with respect to the following drawing figures, in which like numerals represent like features throughout the figures, and in which:

FIG. 1 is a perspective view illustrating the formation of a connection using a wedge connector and wedge connector tool with a gas release knob suitable for use with a power tool;

FIG. 2 is a perspective view of a breech cap assembly of FIG. 1, shown in isolation;

FIG. 3 is a side elevational view of the breech cap assembly of FIG. 1;

FIG. 4 is an end elevational view of the breech cap assembly of FIG. 1;

FIG. 5 is a flow diagram illustrating a method for operating the tool of FIG. 1;

FIG. 6 is a perspective view of a gas release knob assembly in accordance with another embodiment of the invention; and

FIG. 7 is a second perspective view of the gas release knob assembly of FIG. 6.

### DETAILED DESCRIPTION

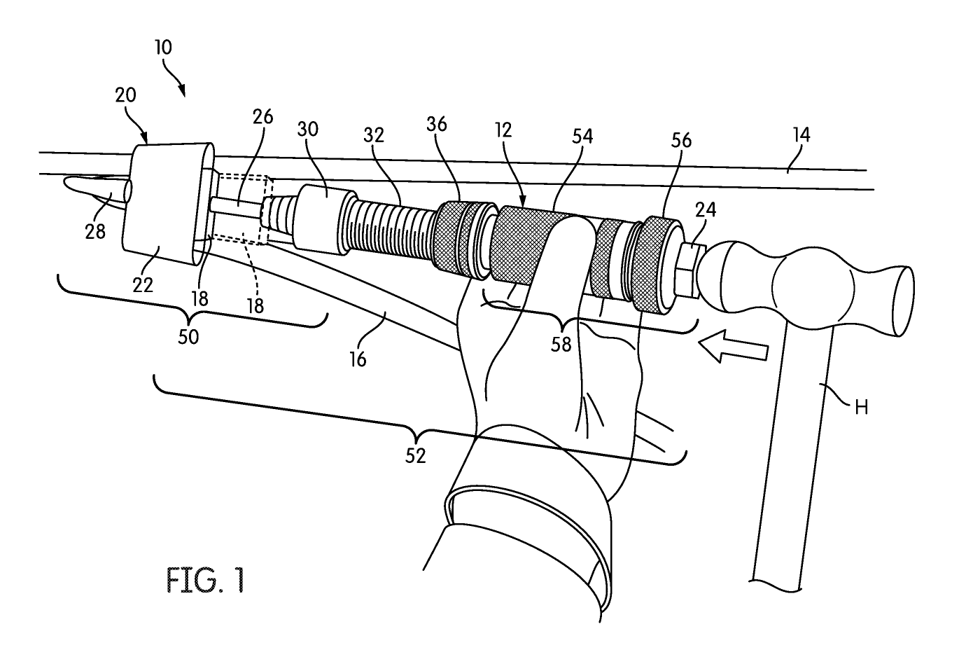

FIG. 1 is a perspective view of a tool assembly 10, illustrating the formation of a connection between two power lines 14, 16 using a wedge connector 20 and powder-driven ram connecting tool 12 according to an embodiment of the invention. The tool 12 of FIG. 1 has the same basic features as the traditional AMPACT® powder-driven ram connecting tool; therefore, unless otherwise indicated, it may be assumed to have the features described, e.g., in U.S. Pat. No. 6,851,262, which was incorporated by reference in its entirety above.

As illustrated in FIG. 1, the wedge connector 20 comprises a C-shaped sleeve 22 and a tapered wedge 18. The wedge 18 is conductive, made, for example, of aluminum, and may have elongate channels along each side edge, corresponding to the dimensions of the main-power line 14 and the branch or tap wire 16, allowing the wedge 18 to be forced between the two power lines 14, 16. In order to complete the connection 20, the wedge 18 is forcibly driven into position by the tool's ram 26. The ram 26 itself is driven by an explosive force generated by a firing a powder cartridge within the breech cap assembly 58 of the tool 12. Specifically, when a hammer H taps the tightened breech cap 56 at the end of the tool, a firing pin (not shown) within the assembly 58 fires the cartridge.

The tool 12, as illustrated in FIG. 1, generally comprises a tool head 50, a power unit 52, and a breech cap assembly 58. The tool head 50 includes an anvil 28 that secures the connector sleeve 22 while the wedge 18 is explosively driven into place, and additionally, ensures the wedge 18 is driven an appropriate amount into the sleeve 22 to form a proper connection 20. Additionally, the tool head 50 includes a support sleeve 30, which is threaded along an interior surface to receive a threaded coupling 32 from the power unit 52.

The power unit 52 generally comprises the threaded coupling 32, the ram 26, and a coupling nut 36. The coupling 32 is threaded in order to allow for relatively fine adjustments of the power unit 52 relative to the tool head 50. Adjustments to the length of the tool 12 may be made by rotating the coupling nut 36, which is configured to allow for a variety of sizes of wedge connectors 20 be used. As shown in FIG. 1, the coupling nut 36 has a larger diameter than the diameter of the coupling 32, and additionally has a knurled texture for facilitating hand adjustments to the tool 12 made by an operator wearing gloves.

The coupling 32 serves as a housing for the ram 26, in that the ram 26 is slideable within and may fully retract into the coupling 32. One end of the ram 26 is used as a striking surface that extends past the coupling 32 (i.e., for striking the wedge 18 during installation, or striking the sleeve 22 in order to remove the connection 20), whereas the opposite end of the ram 26 has a firing pin (not shown) and is configured to be driven by an explosive force produced by a cartridge housed within the breech cap assembly 58. The striking end of the ram 26 is configured to protrude from the coupling 32 a fixed amount, such that the drive end of the ram 26 is prevented from leaving the coupling 32 and the breech cap assembly 58.

FIG. 1 shows the breech cap assembly 58 of the tool 12, comprising a breech cap sleeve 54, a gas release knob 56 and an adapter 24. The breech cap sleeve 54 and the gas release knob 56 both have a knurled surface that is intended to improve grip for the operator when tightening or loosening the tool 12 manually. The breech cap assembly 58 is coupled to the power unit 52 with threads on an internal surface of the breech cap sleeve 54, corresponding to threads on an exterior surface of the power unit 52. The breech cap sleeve 54 may be unscrewed and removed in order to access the breech (not shown) for the purpose of removing and replacing a cartridge.

Additionally, near one end of the breech cap assembly 58 is the gas release knob 56, which is threaded and removably attached to the breech cap sleeve 54. The rear surface of the gas release knob 56 serves as a striking point for a hammer H, as the impact force of the hammer H on the knob 56 drives a firing pin into a powder cartridge within the breech cap sleeve 54 to fire it. Prior to firing the charge, the gas release knob 56 would be tightened in place, such that the breech is sealed and the gases produced by the firing drive the ram 26 forward a fixed distance, out of the coupling 32. Once a cartridge has fired, the gas release knob 56 is usually loosened partially, allowing gas to escape. However, during routine operation, the gas release knob 56 is not detached completely from the breech cap sleeve 54, as will be described in more detail below.

As shown in FIG. 1, an adapter 24 extends from the bottom of the gas release knob 56 of the breech cap assembly 58. The adapter 24 may be integrated with the gas release knob 56, such that the adapter 24 and gas release knob 56 are made as a single, unitary piece. In other embodiments, the adapter 24 may be attached to the gas release knob 56 by other means, such as by welding, brazing, or adhesives. The adapter 24 becomes the striking surface for the hammer H, which triggers the tool 12.

The adapter 24 does not alter the basic way in which an AMPACT® tool is used and allows for normal operation of the tool 12 using an operator's hands, if the operator so desires. However, the adapter 24 also allows an operator to use a torque-applying hand or power tool to assist in both opening and closing the gas release knob 56 and the breech cap sleeve 54. As those of skill in the art will appreciate, this allows tool-driven clockwise and counterclockwise rotation of the gas release knob 56, with the axis of rotation aligned with the longitudinal centerline of the tool 12.

Any type of torque-applying tool may be used to engage and drive the adapter 24. In this description, a torque-applying tool is any type of tool other than a human hand that can engage and apply torque to the adapter 24 to turn the gas release knob 56. Torque-applying tools may include traditional fixed-size wrenches, adjustable wrenches, socket wrenches, flare wrenches, and screw guns. The term “screw gun,” as used in this description, refers to a handheld, powered torque-applying tool. While a screw gun is typically electrically powered (e.g., by a rechargeable battery pack), pneumatic and hydraulic screw guns may be used as well. The use of a power tool may reduce the “cycle time” of the tool—i.e., the amount of time it takes to release gas from the breech and re-load another powder cartridge.

As is shown in FIG. 1, the adapter 24 generally resembles a hex nut. Thus, a screw gun equipped with an appropriately-sized hex socket can engage with the adapter 24 and either loosen or tighten both the breech cap sleeve 54 and gas release knob 56 quickly, relative to performing those same functions manually.

Any part of the adapter 24 may be engaged to drive the gas release knob 56 and breech cap sleeve 54. For example, if the adapter 24 has threads disposed along an interior surface 72, an appropriately threaded rod may be used to engage the adapter 24.

Of course, the adapter 24 need not resemble a hex nut; in other embodiments, the adapter 24 could be of any size or shape, and it could be either male or female—so long as it can be engaged by a hand tool or power tool. If the adapter 24 is male, it may resemble, e.g., a square nut, a cap nut, etc. A female adapter may have a socket for, e.g., an Allen or Torx® key. In some cases, the adapter 24 could have both male and female engaging features. For example, the exterior surface of the adapter 24 may be configured to engage with a hex socket, while the interior surface 72 of the adapter 24 may be configured to engage with an Allen key.

In FIG. 1, the hammer H has struck the adapter 24, which triggers the tool 12, driving the wedge 18 from an initial position (shown in phantom) into its final position. A proper connection 20 is formed when the main power line 14 is secured between an upper part of the sleeve 22 and an upper edge of the wedge 18, while the branch line 16 is secured between a lower part of the sleeve 22 and a lower edge of the wedge 18.

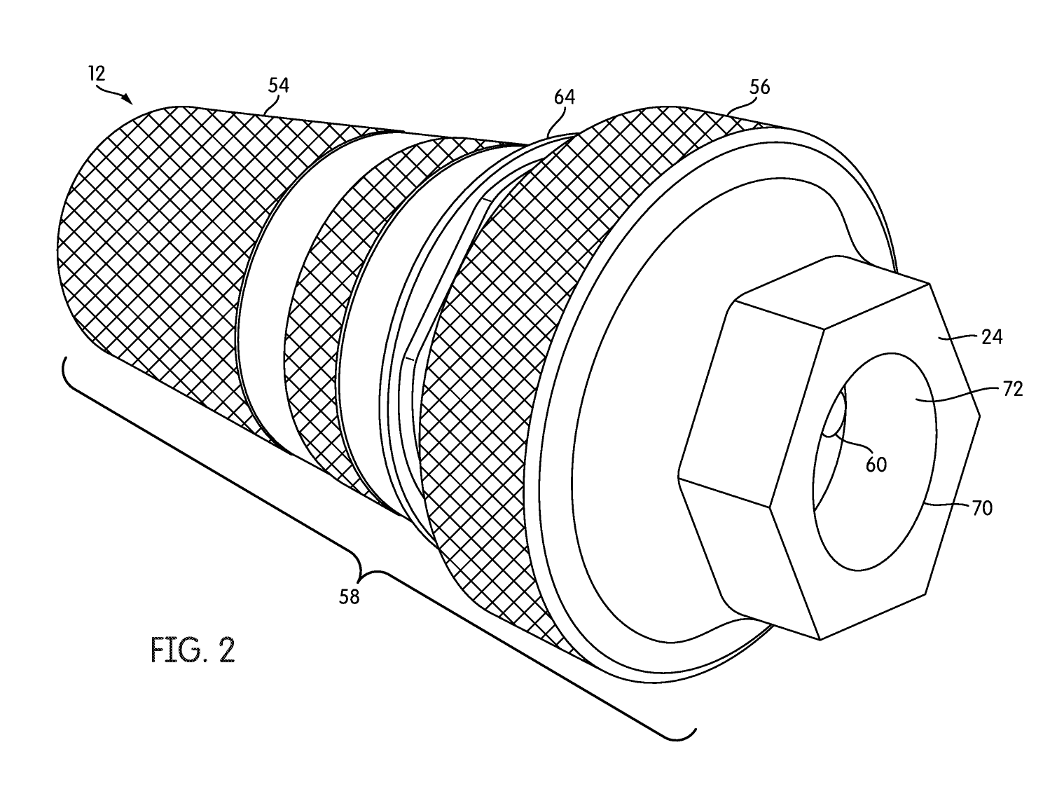

FIG. 2 is a perspective view of the breech cap assembly 58, in isolation. As is shown in FIG. 2, the adapter 24 is fixed to the gas release knob 56, and the gas release knob 56 is coupled to the breech cap sleeve 54 by a series of corresponding threads (not shown). However, the gas release knob 56 is prevented from being removed entirely from the breech cap sleeve 54 during routine operation by a retaining spring 64. The retaining spring 64 is removably attached to the breech cap sleeve 54, and prevents disengagement of the gas release knob 56 from the breech cap sleeve 54. If the retaining spring 64 is removed, for example while performing maintenance on the tool 12, the threads of gas release knob 56 are then expected to completely detach from the breech cap sleeve 54.

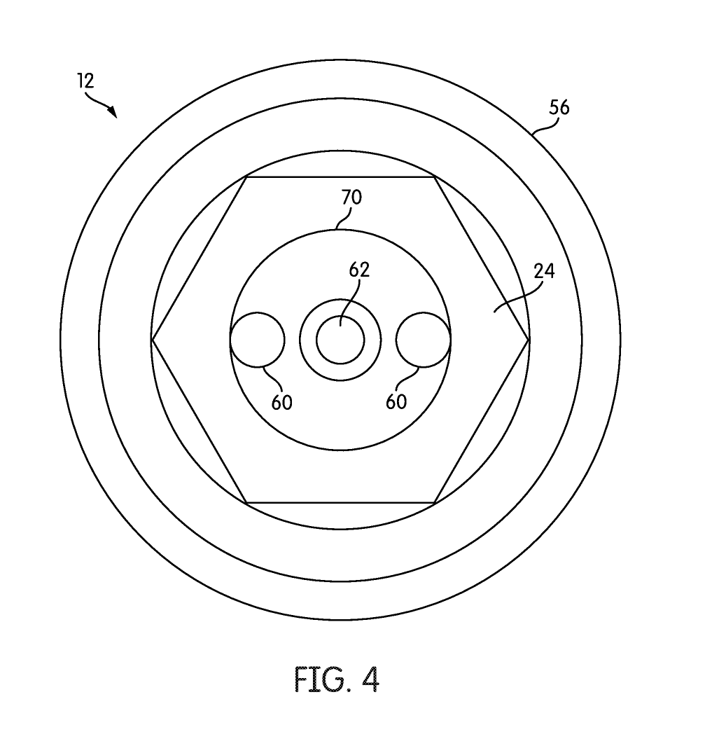

Furthermore, as FIG. 2 shows, the adapter 24 is centered on the end or bottom surface of the gas release knob 56. While the size and shape of the adapter 24 may vary, the adapter 24 is preferably sized and shaped so as not to obstruct the release of gas from the breech or any other normal functions of the tool 12. Specifically, in the illustrated embodiment, the adapter 24 has an opening or outlet 70 sized to allow a pair of gas portholes 60 (best seen in FIG. 4) to vent properly. If the adapter 24 does not have a large outlet 70, it may include its own gas release portholes that are contiguous with openings in the gas release knob 56.

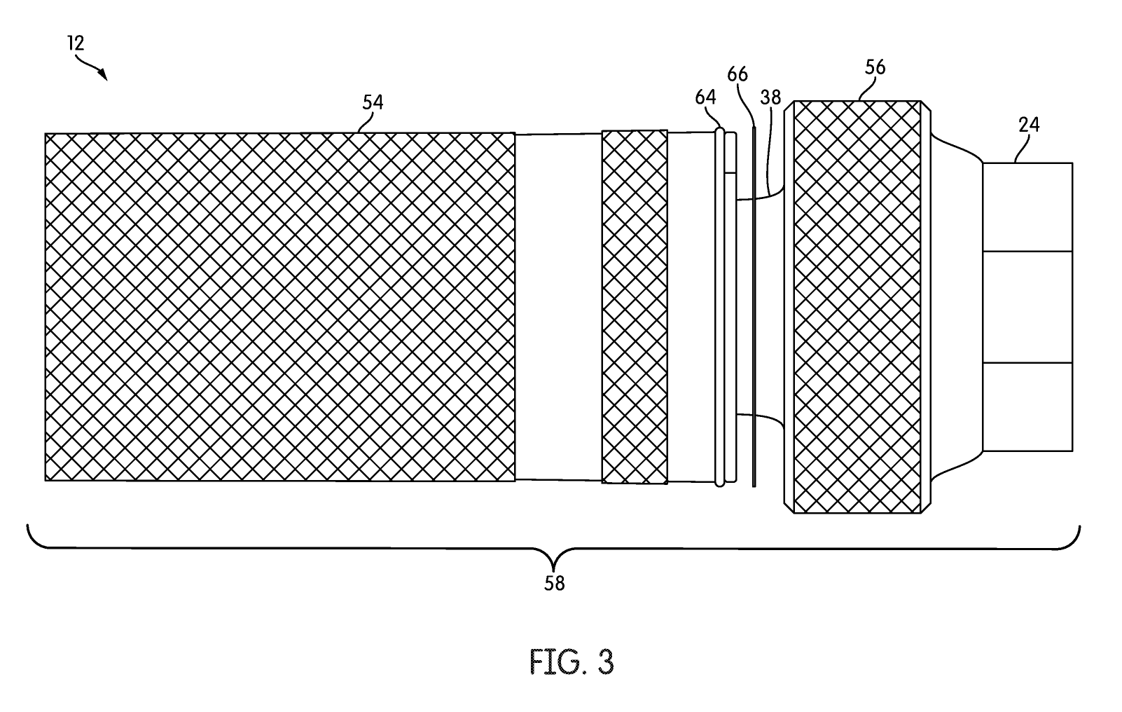

FIG. 3 is a side elevational view of the breech cap assembly 58 and FIG. 4 is an end elevational view of the breech cap assembly 58. As was noted briefly above, the adapter 24 is integral to the gas release knob 56, and serves as an impact surface for triggering the tool 12.

In FIG. 3, the gas release knob 56 is loosened to an extent, limited by the retaining spring 64, which is configured to pass smoothly over the reduced diameter of a gas release knob coupling 38. The gas knob coupling 38 has a smaller diameter than the threads that are disposed on the coupling 38, and thus, the spring 64 prevents the gas release knob 56 from becoming unthreaded. Furthermore, an anti-bind washer 66 is moveably mounted around the gas knob coupling 38, between the knob 56 and the threads (not shown) corresponding to the breech cap sleeve 54. The washer 66 is expected to prevent the gas release knob 56 from sticking to the breech cap sleeve 54 after repeated strikes with a hammer H from routine use, in which additional dust and residue may accumulate and prevent the knob 56 from functioning properly.

FIG. 4 shows the positioning of the adapter 24 on the gas release knob 56 in relation to the pair of gas portholes 60. The adapter 24 is fixed in place and is configured to allow the gas portholes 60 to vent, without obstruction, through the opening 70, which functions as an open inlet and outlet. Additionally, routine maintenance of the gas portholes 60 may be carried out with the adapter 24 installed, for example, after repeated use, the gas portholes 60 may become clogged with residue and require cleaning.

While FIG. 4 shows an opening 70, essentially making the adapter 24 hollow, that need not always be the case. In some embodiments, there may not be an opening 70, in which case the adapter 24 would be substantially solid. However, in order to allow the gas to properly vent, the adapter 24 itself may have gas portholes 60 and firing pin 62 access holes (not shown). A solid adapter may also have a socket, as described above, to engage with a tool.

FIG. 4 also illustrates the position of the firing pin 62—it is centered on the gas release knob 56, extending into the breech cap sleeve 54. As those of skill in the art will appreciate, this positioning of the firing pin 62 anticipates use with a “center-fire” cartridge; if the tool 12 is to be used with “rim-fire” cartridges, the firing pin 62 may be placed off center.

As shown in FIG. 4, the adapter 24 has the shape of a hex nut, having an opening 70 with a minimum basic diameter large enough that the gas portholes 60 fit within it. For example, a ¾ inch hex nut, and corresponding socket, may be just large enough to allow gas to vent properly, whereas, a 15/16 inch hex nut easily allows gas to vent properly. While the size of the adapter 24 may vary, the adapter 24 will generally be of lesser diameter than the gas release knob 56—small enough to be gripped by a torque-applying tool. While that need not be true of all embodiments, a relatively small adapter 24 is an advantage: very large hex sockets—or other driving tools—may not be frequently carried in the field, and may be more unwieldy to use.

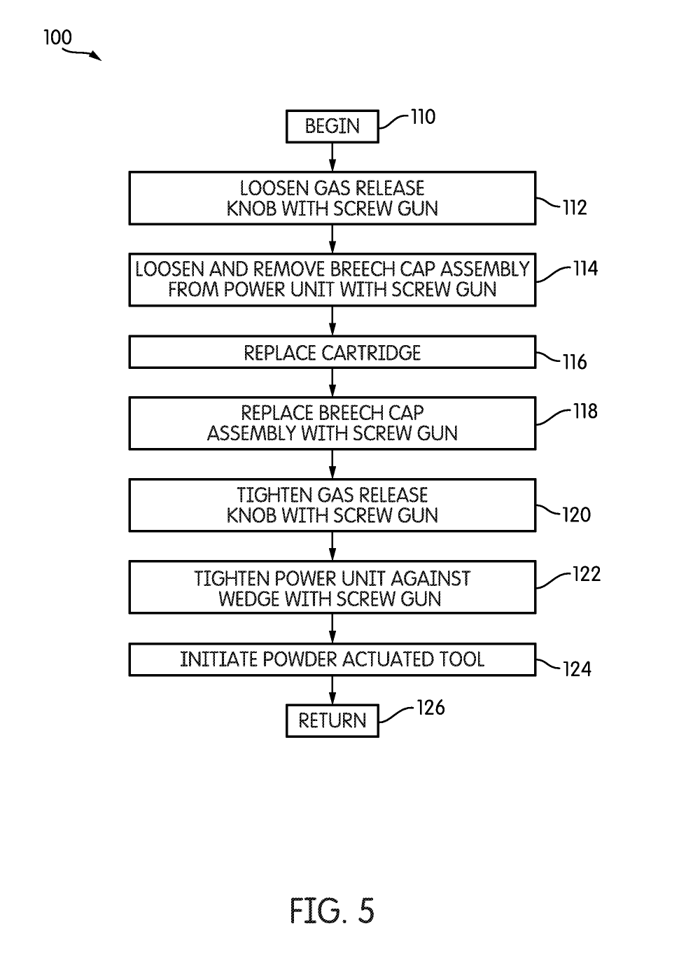

FIG. 5 is a flow diagram illustrating a method of creating a proper connection between power lines using the tool 12, generally indicated at 100. Method 100 begins at task 110 and continues with task 112. Task 112 involves loosening the gas release knob 56, which retracts the firing pin 62, allowing gas to vent from the pair of portholes 60. Task 112 is performed with a screw gun in method 100, whereas it would normally be performed by hand. During task 112, the gas release knob 56 is prevented from being removed from the breech cap assembly 58 by a retaining spring 64, as was described above.

Once the retaining spring 64 catches on the threads of the gas release knob 56, continued operation of the screw gun will ultimately remove the breech cap, as shown in task 114.

Method 100 continues with task 116, and the user either replaces a spent cartridge with a new one or simply inserts a new cartridge. Once task 116 is complete, the breech cap assembly 58 is replaced on the power unit 52 using a screw gun engaged with the adapter 24, as shown in task 118. Once task 118 is completed, the gas release knob 56 may be tightened using the adapter 24 and a screw gun, as shown in task 120 of method 100. While shown separately for ease in description, there may be very little distinguishing task 118 from task 120; these two tasks 118, 120 may be completed in one swift motion using a screw gun.

Once task 120 has been executed, the tool 12 is prepared for use, and it is tightened against the wedge 18 (task 122), before being fired by striking the adapter 24 with a hammer H or any suitable impact device (e.g., the butt-end of a torque applying tool), as shown in task 124. Once task 124, has been completed, a wedge connection has been formed, and method 100 is complete.

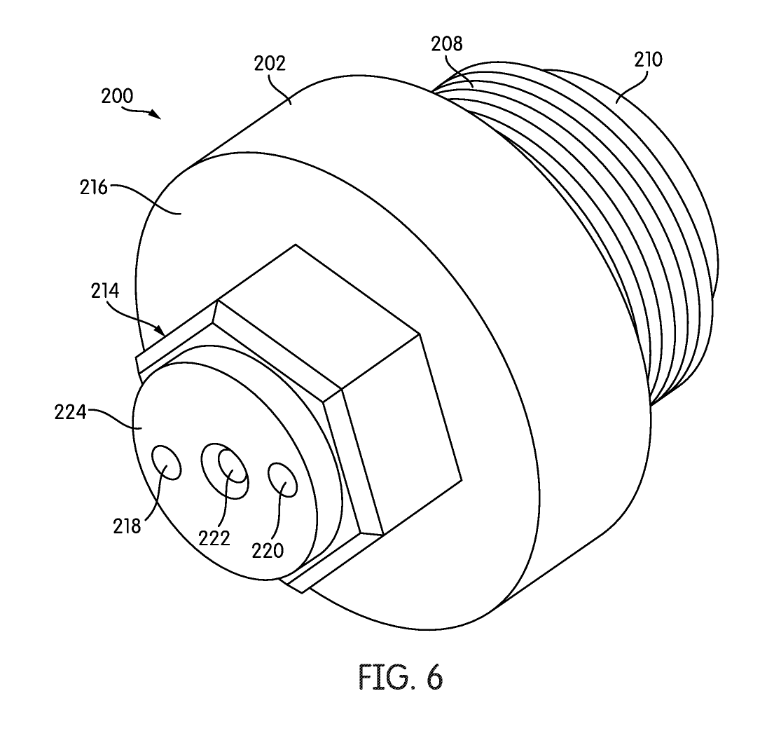

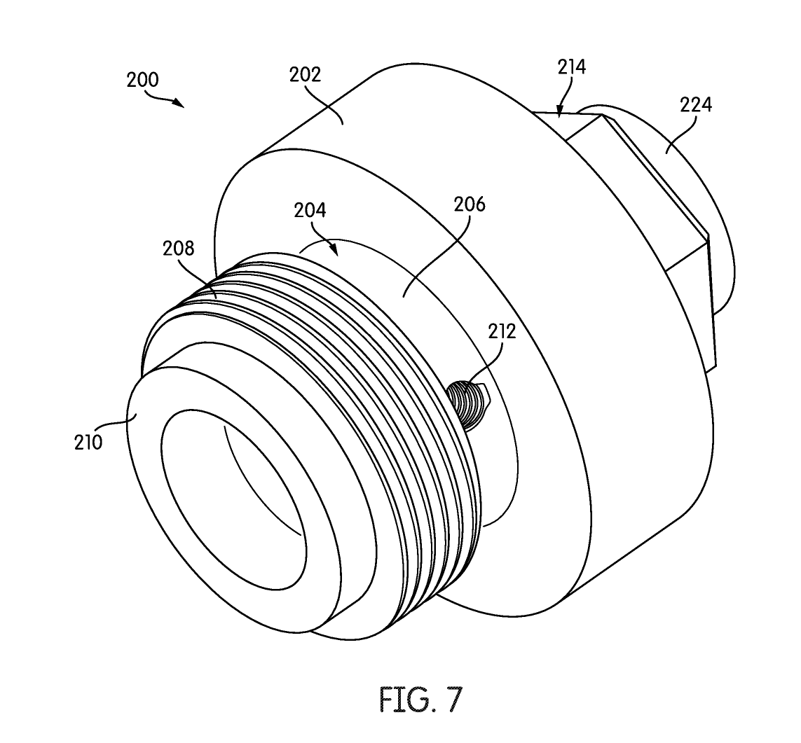

FIG. 6 is a perspective view of a gas release knob assembly, generally indicated at 200, according to another embodiment of the invention, and FIG. 7 is a perspective view of the gas release knob assembly 200 from another angle. The gas release knob assembly 200 replicates the essential features of the assembly described above: a large gas release knob 202 is integrally connected to a hollow, cylindrical coupling portion 204 that has a narrow neck 206 close to the gas release knob 202 with wider-diameter threads 208 farther from the gas release knob 202 that allow the gas release knob assembly 200 to engage the complementary threads of a breech cap sleeve 54 or a similar structure. Beyond the threads 208, the assembly 200 terminates in a cylindrical lip 210, once again of lesser diameter than the threads 208. The neck 206 has a radially-extending threaded hole 212 for a set screw. Generally speaking, the gas release knob assembly 200 is designed to be a one-for-one replacement of the comparable structure of a typical AMPACT® tool, and can also replace the comparable structure from the tool 12 described above.

Like in the tool 12 described above, an adapter 214 is fixedly attached to the rear surface 216 of the gas release knob 202. The adapter 214 of the illustrated embodiment is male and, like the adapter 24 described above, has a hexagonal shape, mirroring that of a hexagonal drive head suitable for use with a traditional hex socket driver. Of course, other shapes are possible. Like the adapter 24, the adapter 214 is of a smaller diameter or width than that of the gas release knob 202, such that it is adapted to be engaged and driven by a torque-applying tool. A ¾-inch width, adapted for a ¾-inch socket, is particularly suitable in the case of a hex-shaped adapter 214, although other widths may be used as well.

The adapter 214 differs from the adapter 24 in some respects. For example, as was described briefly above, adapters according to embodiments of the present invention may be solid. More particularly, where the adapter 24 has a large opening 70 that permits access to gas portholes 60 that extend through the gas release knob 202, the adapter 214 has no such opening. Instead, the adapter 214 is solid. The necessary portholes 218, 220, as well as the center hole 222 that is aligned with the firing pin, extend through the thickness of the gas release knob 202 and the adapter 214.

The adapter 214 differs from the adapter 24 in some other respects as well. For example, the gas release knob 202 of the adapter 214 is not knurled. While the gas release knob 202 may be knurled in some other embodiments, since the adapter 214 allows the assembly 200 to be actuated with a tool, the need for knurling, which allows for easier manual actuation, is vastly reduced.

Additionally, as can be seen best in FIG. 6, there is a short, generally cylindrical projection 224 that extends rearwardly from the adapter 214, terminating in a flat striking surface at which the three openings 218, 220, 222 terminate. Of course, the three openings 218, 220, 222 may terminate anywhere, including the sides of the adapter 214, or even in an area of the gas release knob 202. However, for purposes of manufacturing and later cleaning of the tool 12, it may be easiest to maintain straight pathways for the three openings 218, 220, 222, and for that reason, it may be most advantageous for the three openings 218, 220, 222 to have a straight pathway that begins at an inner surface of the gas release knob 202 and opens either at the rearward-most surface of the adapter 214 or at the rearward striking surface of the projection 224.

The projection 224, which may extend a few millimeters beyond the main portion of the adapter 214, is not long enough to cause problems seating a socket or other driver on the adapter 214. However, it provides a flat striking surface for striking the rear of the assembly 200 to fire the powder charge and actuate the tool 12, as illustrated in FIG. 1. While the projection 224 is an optional feature, a striking surface that extends beyond the adapter 214 may prevent repeated hammer strikes from damaging the adapter 214, which could conceivably prevent it from engaging with a tool. Of course, the assembly 200 may be made of a particularly hard, durable tool steel, such as 4130 alloy tool steel, which may reduce the possibility of damage after repeated strikes.

As with the adapter 24 of FIGS. 1-5, the adapter 214 of FIGS. 6-7 may have any shape, and may be shaped for a square driver, a hex driver, or any other common shape. Additionally, in some embodiments, the adapter 214 may have a unique shape different from those of typical sockets and drivers, so that it must be driven be a socket with a corresponding unique shape.

While the invention has been described with respect to certain embodiments, the embodiments are intended to be exemplary, rather than limiting. Modifications and changes to the invention may be made within the scope of the invention.

What is claimed is:

1. A breech cap assembly for a powder-actuated connecting tool, comprising:
a hollow, cylindrical sleeve, threaded at both ends;
a cap threadedly engaged on one end of the sleeve, the sleeve and cap together defining a breech for a powder cartridge; and
an adapter on an end exterior surface of the cap, the adapter being narrower than a width or diameter of the cap and being sized and configured to be engaged by a torque-applying tool.

2. The breech cap assembly of claim 1, the cap further comprising one or more gas release ports.

3. The breech cap assembly of claim 2, wherein the adapter has an exterior shape of a hex nut or a square nut.

4. The breech cap assembly of claim 2, wherein the adapter is hollow and provides clearance for the gas release ports.

5. The breech cap assembly of claim 2, wherein the adapter is solid and the gas release ports extend through the cap and the adapter.

6. The breech cap assembly of claim 1, wherein the adapter is shaped to engage a hex socket.

7. The breech cap assembly of claim 1, further comprising a retaining member attached to the breech cap sleeve, the retaining member being adapted to prevent removal of the cap from the breech cap sleeve.

8. The breech cap assembly of claim 1, wherein the adapter is formed integrally with the cap.

9. The breech cap assembly of claim 1, wherein the adapter is secured to the cap by welding, brazing, or adhesives.

10. A powder-driven connecting tool, comprising:
a tool head including an anvil;
a power unit including a ram; and
a breech cap assembly including
a hollow, cylindrical sleeve, threaded at both ends,
a cap threadedly engaged on one end of the sleeve, the cap having an inwardly-extending firing pin coupled to an inner surface thereof, the sleeve and cap together defining a breech for a powder cartridge, and
an adapter on an end exterior surface of the cap, the adapter being narrower than a width or diameter of the cap and being sized and configured to be engaged by a torque-applying tool;
wherein the breech is arranged in communication with the ram, such that when the powder cartridge is fired inside the breech, the ram is driven toward the anvil.

11. The powder-driven connecting tool of claim 10, the cap further comprising one or more gas release ports.

12. The powder-driven connecting tool of claim 11, wherein the adapter has an exterior shape of a hex nut or a square nut.

13. The powder-driven connecting tool of claim 11, wherein the adapter is hollow and provides clearance for the gas release ports.

14. The powder-driven connecting tool of claim 10, wherein the adapter is shaped to engage a hex socket.

15. The powder-driven connecting tool of claim 10, further comprising a retaining member attached to the breech cap sleeve, the retaining member being adapted to prevent removal of the cap from the breech cap sleeve.

16. The powder-driven connecting tool of claim 10, wherein the adapter is formed integrally with the cap.

17. The powder-driven connecting tool of claim 10, wherein the adapter is secured to the cap by welding, brazing, or adhesives.

18. A gas release knob assembly, comprising:
a hollow cylindrical portion with a set of external threads;
a solid, cylindrical gas release knob, broader in diameter than the hollow cylindrical portion, spaced from the set of external threads along the length of the hollow cylindrical portion and capping one end of the hollow cylindrical portion;
an adapter projecting from a rear surface of the gas release knob; and
at least one gas release port extending from the interior of the cylindrical portion, through the gas release knob and the adapter and opening in a rear surface of the adapter.

19. The gas release knob of claim 18, wherein the adapter has the form of a male drive head.

20. The gas release knob of claim 19, wherein the adapter has the form of a male hexagonal drive head.
